(19) United States
(12) Patent Application Publication
(10) Pub. No.: US 2014/0131435 A1
(43) Pub. Date: May 15, 2014

(54) Article identification apparatus and method of using same

(71) Applicants: Robert Harrington, Asheville, NC (US); Jason Weiss, Katy, TX (US)

(72) Inventors: Robert Harrington, Asheville, NC (US); Jason Weiss, Katy, TX (US)

(21) Appl. No.: 13/694,226

(22) Filed: Nov. 9, 2012

(51) Int. Cl. G06K 19/077; G06F 17/30

(52) U.S. Cl. CPC G06K 19/07762; G06F 17/30
USPC 235/375; 235/492

(57) ABSTRACT

An article identification apparatus in the form of a member securely located on the article and having the capability of broadcasting a discrete electronic digital signature to a wireless mobile communication device which in turn includes the capability of preparing various editable data files documenting or relating to an event relating to use of the article wherein each such editable file includes the discrete digital signature of the article. The article may comprise a handcuff assembly, and the event may be the arrest of a prisoner upon which the handcuff assembly is used.

### BACKGROUND OF THE INVENTION

1. Field of the Invention

The present invention relates generally to an apparatus for discretely identifying articles, and, more particularly, to an apparatus for identifying articles used in law enforcement such as handcuffs or personal restraints, and the methods of using same.

2. Description of the Prior Art

Personal restraints or handcuffs are well known in the art. In U.S. Pat. No. 7,882,599 (naming Robert Harrington as inventor, a joint-inventor named herein), there is fully disclosed a disposable, single-use handcuff apparatus including first and second straps adapted to be drawn through a single locking head and securely tightened about the wrists of a prisoner. When a prisoner is apprehended, it is important to document the facts associated with the event and preserve those facts in an “arrest file.” The integrity of such a file may be enhanced if the handcuffs used in the arrest were given a readily identifiable signature or “finger print” which, in turn, might be associated with each of the various forms of the data collected during and in connection with the arrest.

This need is met by the present invention which provides means for assigning a unique discrete precise electronic digital signature to each handcuff apparatus and a method of subsequently accessing that digital signature or “electronic fingerprint” in order to associate that precise identification and the handcuff apparatus on which it is applied with each of the various forms of data collected during an arrest event where the handcuff apparatus is used on a prisoner.

The foregoing and still other desired characteristics are provided by the unique article identification apparatus and method of using same of the present invention as will be made apparent from the following description thereof. Other advantages of the present invention over the prior art also will be rendered evident.

### SUMMARY OF THE INVENTION

To achieve the foregoing and other advantages, the present invention, briefly described, provides an article identification apparatus and the methods of using same in the form of a handcuff apparatus having discrete identifying means located in a secure location on the locking head portion of the handcuff assembly. The discrete identifying means is capable of broadcasting an electronic digital signature to a wireless mobile communication device which in turn includes means for preparing various editable data files documenting or relating to an event during which the handcuff assembly is used on a prisoner.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved article identification apparatus and methods of using same which possess substantial advantages over the prior art.

An even further object of the present invention is to provide a new and improved article identification apparatus and methods of using same in the form of a handcuff apparatus having discrete identifying means located in a secure location on the locking head portion of the handcuff assembly.

Still yet another object of the present invention is to provide a new and improved article identification apparatus and methods of using same in the form of a handcuff apparatus having discrete identifying means located in a secure location on the locking head portion of the handcuff assembly and wherein the discrete identifying means is capable of broadcasting an electronic digital signature to a wireless mobile communication device which in turn includes means for preparing various editable data files documenting or relating to an event during which the handcuff assembly is used on a prisoner.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is an elevational view of a first preferred embodiment of a disposable, single use handcuff apparatus of the present invention.

FIG. 2 is a cross-sectional view taken along line 2-2 of the FIG. 1.

FIG. 3 is an elevational view of an alternatively preferred embodiment of the invention utilizing a single strap and a locking head with a single single-strap reception channel.

FIG. 4 is a cross-sectional view taken along line 4-4 thereof.

FIG. 5 is a cross-sectional view taken along line 5-5 thereof.

FIG. 6 is a is a perspective view of a third alternatively preferred form of the present invention.

FIG. 7 is a plan view of a preferred form of RFID tag used in accordance with the present invention.

FIG. 8 is a schematic elevation view showing the various structural elements (layers) of the RFID tag of FIG. 7.

FIG. 9 is a schematic perspective view showing a wireless mobile communication device being employed by a law enforcement officer to read the discrete electronic identifying information encoded on a handcuff apparatus on a prisoner in accordance with the invention.

FIG. 10 is an elevational view schematically depicting a first screen on the wireless mobile device of FIG. 9.

FIG. 11 is an elevational view schematically depicting a second screen on the wireless mobile device of FIG. 9.

FIG. 12 is an elevational view schematically depicting a third screen on the wireless mobile device of FIG. 9.

FIG. 13 is an elevational view fourth screen on the wireless mobile device of FIG. 9.

FIG. 14 is an elevational view schematically depicting a fifth screen on the wireless mobile device of FIG. 9.

FIG. 15 is an elevational view schematically depicting a sixth screen on the wireless mobile device of FIG. 9.

### DESCRIPTION OF THE PREFERRED EMBODIMENTS

With reference to the drawings, preferred embodiments of the present invention embodying the principles and concepts of the present invention now will be described in greater detail.

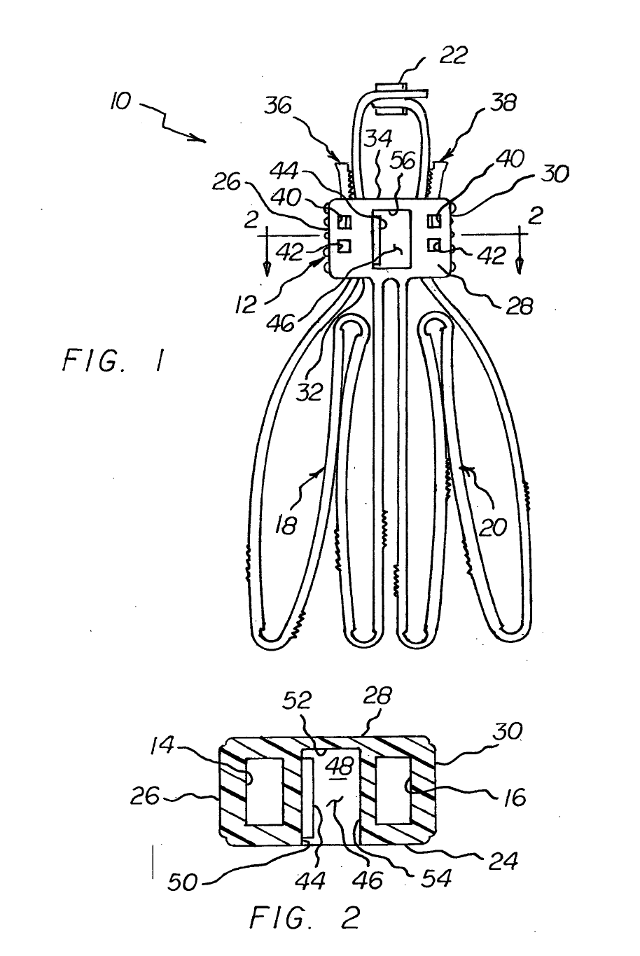

Turning to FIGS. 1 and 2, there is shown a first embodiment of the invention in the form of a handcuff apparatus generally designated by reference numeral 10. Except as improvingly modified in accordance with the teachings of this invention, handcuff apparatus 10 may be the same or similar to that fully disclosed in Harrington—U.S. Pat. No. 7,882,599, the specification of which is hereby incorporated herein by this reference. Thus, as disclosed in the prior '599 patent, handcuff apparatus 10 comprises a locking head or strap support block 12 having a pair of spaced, generally parallel-aligned strap-receiving channels 14, 16 (FIG. 2) for receiving a corresponding pair of foldable straps 18, 20, respectively, the top free ends of which after being received through channels 14 and 16 are adapted to be connected together by a suitable rivet or fastener 22. The opposite ends of straps 18, 20 are integrally attached to the bottom portion of locking head 12 substantially as shown with the locking head and the straps preferably being of one-piece unitary construction such as by being suitably formed of a thermoplastic material via known molding technology.

Locking head 12 has a front end 24, a first side 26, a back end 28, a second side 30, a bottom 32, and a top 34 wherein channels 14, 16 extend from bottom 32 to and through top 34 (FIG. 2). Preferably, a pair of depressible locking clips 36, 38 is adapted to be received respectively in the top portion of channels 14, 16 and moved or depressed downwardly within such channels when desired from a first “unlocked condition” to a second “locked condition” as viewed in FIG. 1.

As further described in the “599 patent, the outer surface of foldable straps 18, 20 includes suitable ratchet teeth for engagement with complimentary ratchet teeth on the confronting facing surface of each locking clip 36, 38. Also, each locking clip 36, 38 preferably has oppositely-extending, flexible lateral prongs for engagement within upper prong reception openings 40 and lower prong reception openings 42 in the front end 24 and back end 28, respectively, of locking head 12. In the “unlocked condition” the prongs are in engagement with the upper prong reception openings 40 and the ratchet teeth on each strap 18, 20 are not engaged by the complimentary ratchet teeth on each locking clip, whereas in the “locked condition” the prongs are in engagement with the lower prong reception openings 42 and the ratchet teeth on each strap 18, 20 are “lockingly” engaged by the complimentary ratchet teeth on each locking clip 24, 26, respectively, all as more particularly described in the aforementioned '599 patent.

In accordance with the present invention, and in its broadest aspect, a useful article typified by handcuff apparatus 10 includes a miniature wireless communication means for sending a discrete electronic identification signal to an external mobile receiving device. Preferably, such means comprises in the context of the embodiment of FIGS. 1 and 2 an “RFID tag” generally indicated by reference sign 44 securely mounted on the handcuff apparatus. More specifically, the locking head 12 of handcuff apparatus 10 includes an RFID tag reception chamber or blind recess 46 formed generally centrally in locking head 12 and having an opening intercepting front end 24 substantially as depicted in FIGS. 1 and 2. Thus, chamber 46 is defined by an interior floor 48, a left interior wall 50, a back interior wall 52, a right interior wall 54, and an interior top or ceiling 56. Preferably tag 44 is securely adhered to the surface of left interior wall 50 as depicted, but it will be understood that tag 44 optionally can be emplaced on the surface of any other part of chamber 46 such as the aforementioned interior floor 48, back interior wall 52, right interior wall 54, or interior top or ceiling 56, if so desired. Chamber 46 not only provides a convenient location for tag 44, but protects it against tampering or mutilation, and renders it conveniently proximal to a receiver as will be explained in more detail below. Inasmuch as handcuff apparatus 10 is formed of a molded thermoplastic material, the formation of chamber or recess 46 in the locking head as shown may be carried out easily and inexpensively by employment of known molding techniques as will occur to those of ordinary skill.

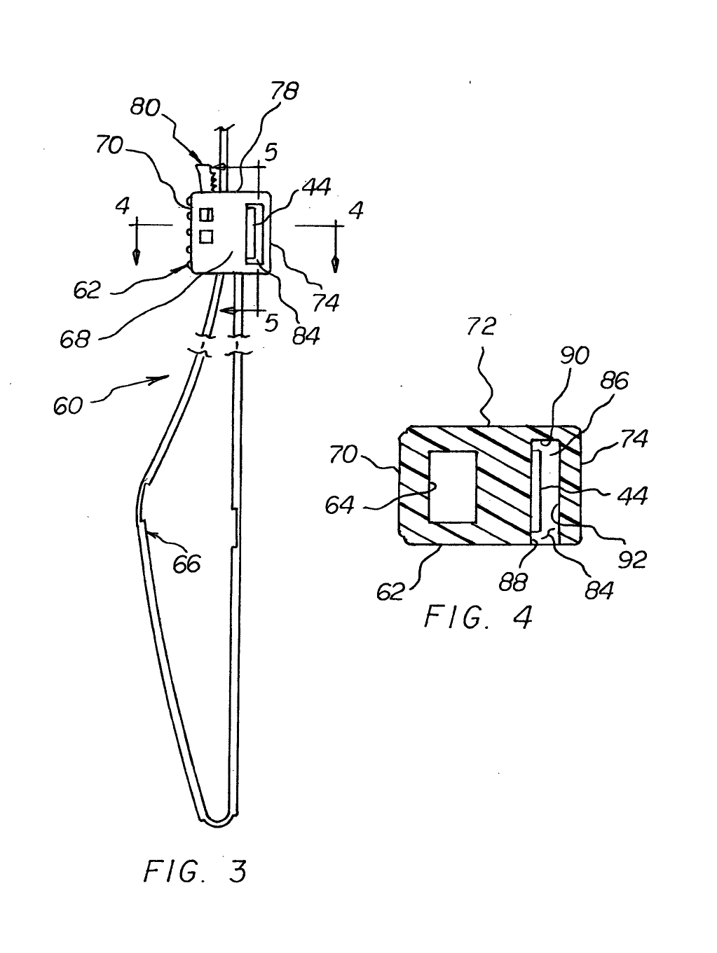

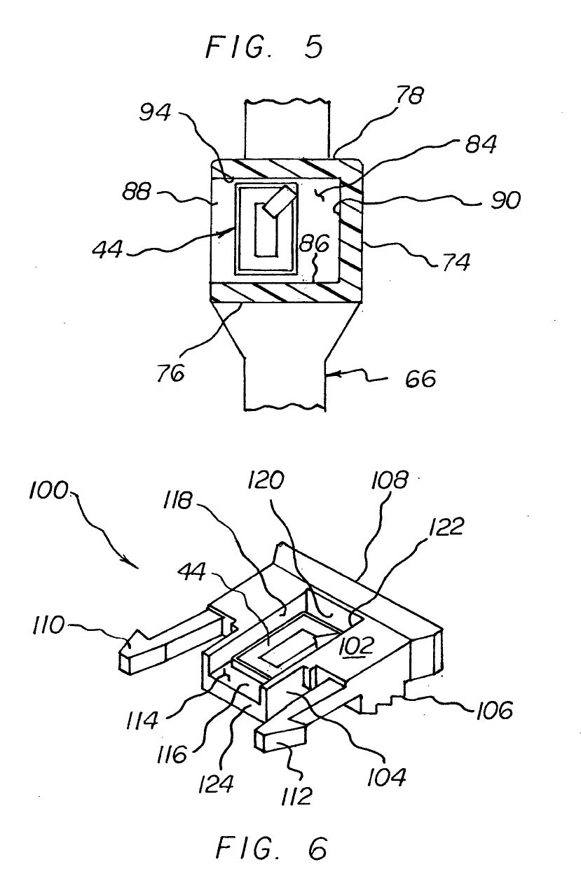

Turning to FIGS. 3-5, there is shown an alternatively preferred embodiment of the invention wherein a single-strap handcuff apparatus 60 is provided in lieu of the double-strap handcuff apparatus embodiment of FIGS. 1 and 2. More specifically, handcuff apparatus 60 includes a single locking head or strap support block generally indicated by reference sign 62 having a single through channel 64 (FIG. 4) for receiving a corresponding single foldable strap 66, the top free end of which is adapted to be inserted into and through the channel 64 from the bottom of the locking head 62 and extend beyond the top of the locking head (FIG. 3). Here again, the opposite end of single strap 66 is integrally attached to the bottom portion of locking head 62 to form a unitary locking head and strap construction preferably of thermoplastic material via known molding technology.

As depicted, locking head 62 is characterized by a front end 68, a first side 70, a back end 72, a second side 74, a bottom 76, and a top 78. Strap reception channel 64 extends through the locking head from bottom 76 to and through top 78 (FIG. 4). Preferably, a single depressible locking clip 80 is adapted to be received in the top portion of channel 64 and moved or depressed downwardly within such channel when desired from a first “unlocked condition” to a second “locked condition” as viewed in FIG. 3. Locking clip 80 can be the same as locking clips 36 and 38 described above in connection with FIGS. 1 and 2.

In accordance with the present invention, the miniature wireless communication means adapted to send a discrete electronic identification signal to an external mobile receiving device, namely RFID tag 44 also is securely mounted on the alternatively preferred handcuff apparatus 60. This is accomplished preferably by providing a tag reception chamber or blind recess 84 in locking head 62 proximal to the right side thereof and having an opening intercepting front end 68 substantially as depicted in FIGS. 3-5.

Tag reception chamber 84 is defined by an interior floor 86, a left interior wall 88, a back interior wall 90, a right interior wall 92, and an interior top or ceiling 94. Preferably tag 44 is securely adhered to the surface of left interior wall 88 as depicted, but as in the prior embodiment of FIGS. 1-2, tag 44 optionally can be emplaced on other surfaces defined by chamber 84 such as the aforementioned interior floor 86, back interior wall 90, right interior wall 92, or interior top or ceiling 94, if so desired. As in the prior embodiment of FIGS. 1-2, chamber 84 provides a convenient location for tag 44 in the context of a single strap, single locking head handcuff apparatus, protects the tag against tampering or mutilation, and renders the tag conveniently proximal to a receiver as will be explained in more detail below. Similarly, the formation of tag reception chamber or recess 84 may be carried out easily and inexpensively with respect to the alternatively preferred handcuff apparatus 60 via known thermoplastic material molding techniques.

It will be understood that specific mounting location of the RFID tag 44 on the handcuff apparatus 10 or 60 is not critical. This is demonstrated by the alternatively preferred embodiment schematically depicted in FIG. 6 which shows a locking head clip 100 suitably modified to house the tag 44. Thus, substantially as shown in FIG. 6, locking clip 100 has a generally smooth first surface 102, a narrowed-width central portion 104, a second opposed surface having a series of ratchet teeth 106, and further includes a top surface 108 adapted for finger-engagement, and a pair of downwardly depending spaced, opposed, flexible prongs 110, 112; and as such, generally is similar to locking clips 36, 38 and 80 previously described. It will be observed, however, that alternately preferred locking clip 100 is modified to include a recess 114 for housing RFID tag 44. Recess 114 which serves as the “tag reception chamber” of this alternatively preferred embodiment is defined by a floor 116 (recessed below the smooth first surface 102), a first side 118, a back 120, and a second side 122; and has openings intercepting the plane of the smooth first surface and the bottom end edge 124 of narrowed-width central portion 104 substantially as shown. Tag 44 advantageously can be adhered to floor 116 and thereby be protected by being recessed within chamber 114 and especially below smooth surface 102 in the manner depicted. By so locating RFID tag 44 on clip 100 serves to further protect the tag because it is housed within the channel within which the clip moves. It will be appreciated that such an arrangement is suitably dimensioned and configured to avoid interfering with the movement and function of the locking clip 100 within that channel.

Preferably, RFID Tag 144 is of the conventional “passive” type adapted to be interrogated by a transmitter-receiver device to send an identifying signal. Two-way radio transmitter-receivers called “interrogators” or “readers” send a signal to the tag and read its response. The reader which may be a mobile communication device includes or is capable of transmitting the observed electronic identifying signal to a computer system running RFID software or RFID middleware. Passive RFID tags or labels typically include a small RF transmitter and receiver. An RFID reader transmits an encoded radio signal to interrogate the tag. The tag receives the message and responds with its identification information. This may be only a unique tag serial number, product-related information such as a stock number, lot or batch number, production date, or other specific information. The “unique” identifying information is encoded in the memory of the tag usually contained in an integrated circuit on the tag. Thus, RFID tags or labels contain at least two parts: an integrated circuit for storing and processing information, modulating and demodulating a radio (RF) signal, collecting DC power from the reader incident signal; and an antenna for receiving and transmitting the signal.

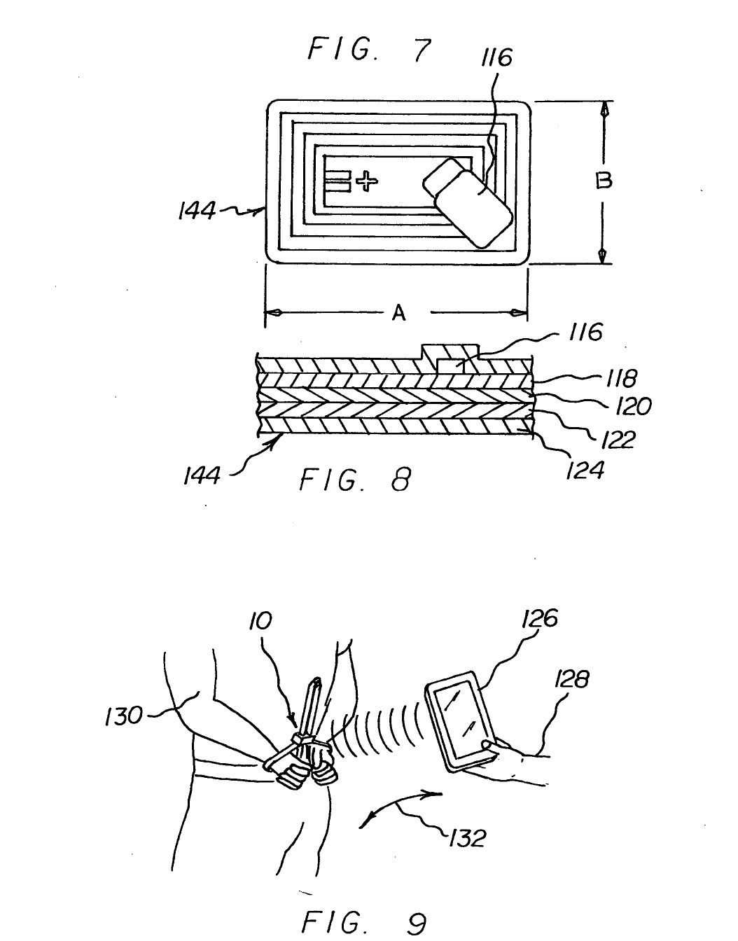

Such RFID tags are widely commercially available with the RFID tag or label distributed by UPM RFID under stock code: NXP NTAG203 being mostly preferred in carrying out the present invention. This mostly preferred tag 144 is depicted schematically in FIGS. 7 and 8 which Figures are borrowed from the UPM/NXP NTAG203 specification sheet. Thus, as shown in FIG. 7, tag 144 generally is rectangular in shape and has a length dimension “A” and a width dimension “B.” To give an idea of the miniature size or scale of the tag: dimension “A” is about 19 mm whereas dimension “B” is about 9 mm, and the overall thickness of the tag package is about 162 μm. FIG. 8 schematically depicts the various structural parts of the tag 144 package. As shown therein an integrated circuit 116 is placed over antenna 118 and covered by a suitable protective face material 118. The integrated circuit and antenna are supported by a substrate (PET) 120 which in turn has a penultimate layer of adhesive 122 on its underside protected by a bottom layer of “release” paper 124. Conveniently, RFID tags 144 are contained on a roll of such release paper 124 containing multiple tags or units 144, each with its own memorized unique electronic identification signal or fingerprint. Each unit, or separate tag, may be peeled off the roll serially, then attached respectively to a discrete article by means of adhesive layer 122. In this manner, it may be seen that an individual RFID tag 144 easily may be attached to wall 50 (FIGS. 1 and 2), or wall 88 (FIGS. 3-5), or floor 114 (FIG. 6) of the disposable, single-use handcuff apparatus contemplated by the present invention. And when this is done, in accordance with the invention, each handcuff apparatus so constructed bears a discrete “readable” electronic code or fingerprint uniquely associated with that particular handcuff apparatus.

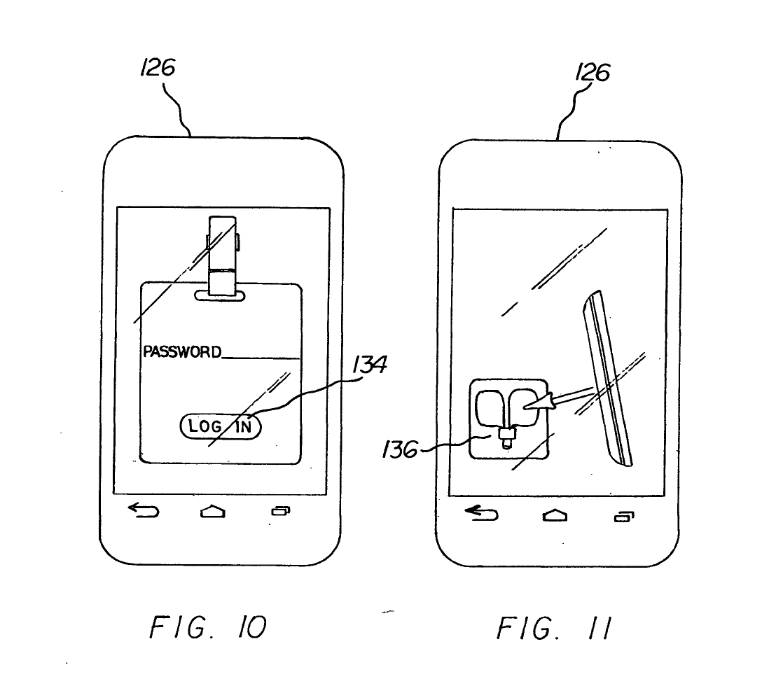

In accordance with another important feature of the present invention, the discrete encoded electronic identification information stored on an RFID tag on a particular handcuff apparatus may be read by a wireless communication device such as a smartphone, for example, and by utilizing software in the form of an application stored in the smartphone's memory, the handcuff apparatus identification information may securely be associated with other information collected during an arrest event. As a result, all of the relevant information pertaining to an arrest and to an arrested prisoner may securely be stored in an electronic file or files and/or transferred to other electronic databases for ultimate processing integrity in the justice system. This is schematically depicted in FIG. 9, where a conventional smartphone 126, held by an arresting officer 128 is shown reading the encoded electronic signature from an RFID tag (not shown) associated with a handcuff apparatus 10 (as in FIGS. 1-2) on an apprehended prisoner or other arrested person 130. In actual practice, all that is required to read the RFID tag signal is to gently tap the back of the smartphone against the handcuff locking head or wave it back and forth in the vicinity of the handcuff apparatus, such action being indicated schematically by arrow 132.

Still yet in accordance with another important feature of the present invention, the smartphone 126 includes a downloaded software application (“app”) capable of reading the electronic encoded identifying signal relating to a tagged handcuff apparatus and associating this discrete information with various other data files managed by the smartphone operating system such as time, date and location (GPS coordinates), photos, audio, text writing and so on. This enables an arresting officer to compile a complete “data” arrest file merely using the smartphone which may then easily be transferred to other smartphones possessed by other persons in the justice system thus maintaining the integrity of the so-called trail of custody because all collected information in the arrest file is indexed relative to the discrete identification on the handcuff apparatus worn by the arrested prisoner. A suitable app capable of fulfilling these functions is commercially available from Tag Dynamics, Inc., Katy, Tex. under the Trademark NEARLAW and is particularly preferred in carrying out the present invention.

To illustrate in an exemplary manner how a smartphone 126 of the “Android” type may operate with the handcuff apparatus of the invention using the downloaded app NEARLAW™, attention is directed to FIG. 9 and to FIGS. 10-16 schematically depicting various screens produced on the smartphone by the app during the following “hypothetical” arrest event:

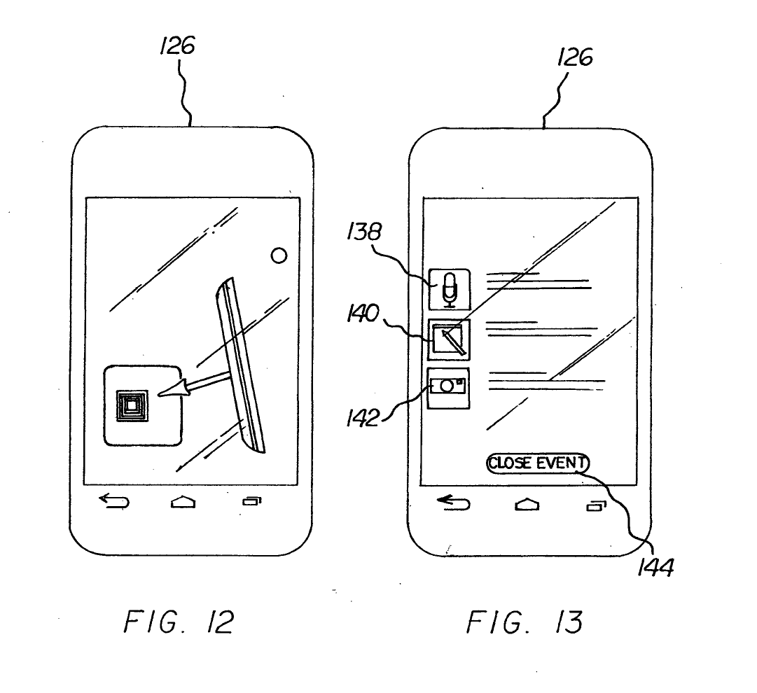

A border patrol agent 128 identifies and pursues an individual 130 illegally attempting to cross the border. The agent pursues the individual, apprehends him, and completes the arrest by applying the handcuff apparatus 10 (see FIG. 9). The agent retrieves his smartphone 126, activates the NEARLAW™ app and “logs in” using tab 134, FIG. 10. The agent then begins the arrest documentary process. Following log in, the screen depicted in FIG. 11 comes up with an icon 136 instructing the arresting agent to “touch the back of the smartphone to the handcuffs 10” whereby the “serial number” or identifying code embedded on the RFID tag automatically is read by the smartphone. The phone's GPS is accessed to capture a precise location of the arrest, and the arrest timestamp is documented using the phone's timestamp function (FIG. 12). The agent then brings up icons or tabs 138, 140, and 142 (FIG. 13) in order to document relevant information about the individual and the “arrest event” itself. Thus, by using tab 138 (audio), the agent may ask the individual to read a pre-defined paragraph and record his voice.

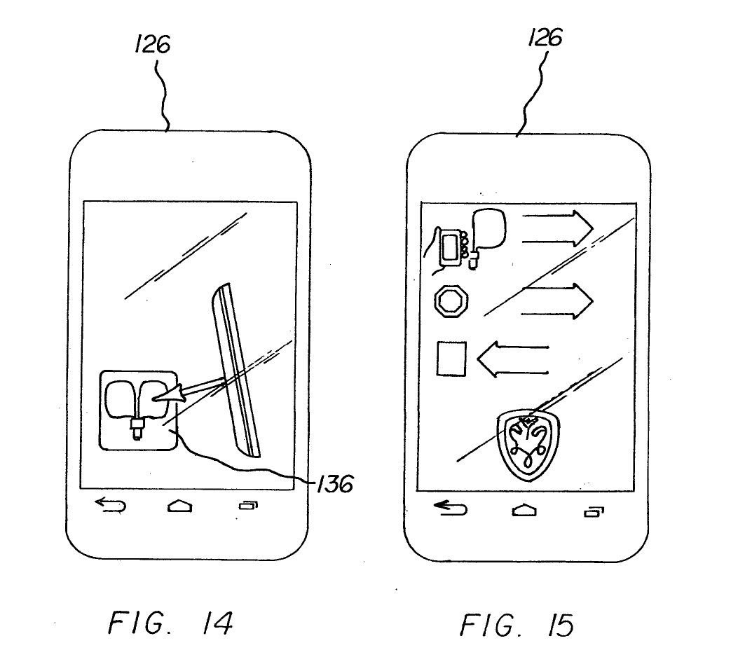

Similarly, by using tab 140, the agent may bring a “notepad” up upon which he can record observations relating to the event arrest (text), and by using tab 142, the agent may use the smartphone's camera to take pictures (or videos) of the man's face or of his iris, or of his footprints in the ground at the crime scene, or any other objects or features related to the event. By touching the “Close Event” tab 144 (FIG. 13) all such collected evidence is then encrypted and stored on the phone in a secure digital “arrest file” which may then be stored in the phone's memory and/or uploaded to the Internet for later use by members of the justice system, as required. It will be appreciated that in the resulting NEARLAW™ “arrest file,” the discrete identification code originally embedded on the handcuff apparatus 10 employed during the arrest event is associated with each and every bit and piece of evidence so collected. Finally, When the agent brings the prisoner into custody and wishes to transfer custody to another agent, he may initiate a “Custody Transfer” function (FIGS. 14 and 15) by again touching his phone to the prisoner's handcuffs and then to the back of another agent's smartphone. In this manner the secure transfer of all digitally encrypted information in the “arrest file” associated with the particular handcuff apparatus 10 (or apparatus 60) used in the arrest securely may be transferred from one agent to another.

As to the manner of usage and operation of the instant invention, the same is apparent from the above disclosure, and accordingly, no further discussion relative to the manner of usage and operation need be provided.

It will be appreciated that in view of the foregoing, the present invention describes new and improved means and methods for securely and accurately documenting substantially all crucial evidence surrounding an arrest event using an relatively inexpensive disposable, single-use handcuff apparatus having an embedded RFID tag with discrete identifying information and a conventional smartphone having a downloaded software application (app) for reading the RFID tag and manipulating and storing the information and the collected evidence associated therewith.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. For example, the “restraining” apparatus of FIGS. 1-5 (both embodiments) while functioning advantageously as a “handcuff apparatus,” may also be used in other applications as well, such as, for example, as a discrete identification “tie” or “secure tag” affixed to or on various and sundry articles.

Hence, the proper scope of the present invention should be determined only by the broadest interpretation of the appended claims so as to encompass all such modifications as well as all relationships equivalent to those illustrated in the drawings and described in the specification.

What is claimed as being new and desired to be protected by Letters Patent of the United States is as follows:

1. An article identification apparatus comprising:
a strap member, and
means on said strap member for storing an electronic signal discretely identifying said strap member.

2. The apparatus of claim 1, wherein said strap member is a personal restraint and said means for storing an electronic signal is an RFID tag.

3. The apparatus of claim 2 wherein said strap has a first end and a second opposed end, and said personal restraint is employed as a handcuff apparatus, said handcuff apparatus further including:
a locking head, said locking head being connected to said first end of said strap member, and wherein said RFID tag is located on said locking head.

4. The apparatus of claim 3 wherein said locking head further includes a strap member reception channel, said second end of said strap member being adapted to be received in strap member reception channel,
said apparatus further including a locking member adapted for movement on said locking head in said strap member reception channel between a first unlocked condition and a second locked condition, and
wherein said RFID tag is mounted on said locking member.

5. The apparatus of claim 3 wherein said locking head includes a first recess and a second recess, said strap member being adapted to be received in and through said first recess, and wherein said RFID tag is located in said second recess.

6. The apparatus of claim 5 wherein first recess is a through-passage in said locking head, and said second recess is a blind recess in said locking head.

7. The apparatus of claim 2 further including in combination:
a smartphone, said smartphone having software for reading said signal on said RFID tag.

8. The apparatus of claim 7 wherein said software is a downloaded software application capable of reading said RFID signal and associating said read RFID signal with additional files in said smartphone.

9. The apparatus of claim 8 wherein said additional files comprise text, audio, photo, and video files contained on said smartphone.

10. The method of documenting an arrest comprising the following steps:
(a) providing a personal restraint having embedded thereon means for storing a discrete electronic identification signal,
(b) affixing said personal restraint to a prisoner under arrest,
(c) providing a wireless communication device capable of reading the electronic signal embedded on said personal restraint provided in step (a), and
(d) reading said discrete electronic identification signal with said wireless communication device.

11. The method of documenting an arrest comprising the following additional steps:
(e) providing said wireless communication device in the form of a smartphone having a memory for storing data in files and,
(f) associating said read discrete identification signal with said data files in said smartphone of step (e).

12. The method of claim 11 wherein said means for embedding a discrete electronic identification signal provided in step (a) is an RFID tag, and wherein said smartphone provided in step (e) is further provided with a downloaded software application capable of reading said discrete identification signal and wherein said step (f) of associating said read discrete identification signal is carried out by said downloaded software application.
